(19) United States
(12) Patent Application Publication
(10) Pub. No.: US 2013/0179227 A1
(43) Pub. Date: Jul. 11, 2013

(54) SYSTEM FOR AND METHOD OF MANAGING BOOK SALES AND RENTALS

(71) Applicants: Cameron Booth, Redwood City, CA (US); Harlan Lewis, San Francisco, CA (US); Delfin Quesada, San Francisco, CA (US); Michael Taylor, Alameda, CA (US); Britt Crawford, San Francisco, CA (US); Nathan Gamble, San Francisco, CA (US); Philippe Huibonhoa, Santa Clara, CA (US)

(72) Inventors: Cameron Booth, Redwood City, CA (US); Harlan Lewis, San Francisco, CA (US); Delfin Quesada, San Francisco, CA (US); Michael Taylor, Alameda, CA (US); Britt Crawford, San Francisco, CA (US); Nathan Gamble, San Francisco, CA (US); Philippe Huibonhoa, Santa Clara, CA (US)

(73) Assignee: RAFTER, INC., San Mateo, CA (US)

(21) Appl. No.: 13/547,969

(22) Filed: Jul. 12, 2012

Related U.S. Application Data
(60) Provisional application No. 61/510,929, filed on Jul. 22, 2011.

(51) Int. Cl. G06Q 10/06

(52) U.S. Cl. CPC G06Q 10/0637
USPC 705/7.35; 705/7.36; 705/7.29; 705/26.61

(57) ABSTRACT

To generate customer loyalty, a management system and method is implemented to ensure a purchase or rental is made while at a store. The management system enables a user to set specific goals or requirements, and then the system provides an interface to the user to reach those goals including generating marketing schemes. The management system is also able to be used by a customer to compare prices of items and make a single purchase of items in disparate locations while in the store.

### RELATED APPLICATION

This patent application claims priority under 35 U.S.C. §119(e) of the co-pending, co-owned U.S. Provisional Patent Application No. 61/510,929, filed Jul. 22, 2011, titled, “SYSTEM FOR AND METHOD OF MANAGING BOOK SALES AND RENTALS,” which is hereby incorporated by reference in its entirety.

### FIELD OF THE INVENTION

The present invention relates to the field of data processing. More specifically, the present invention relates to data processing of pricing, sales, inventory and additional information regarding book sales and rentals.

### BACKGROUND OF THE INVENTION

With the ease of purchasing books online, many college students visit their local college bookstores to receive their needed booklists based on their schedule, but then purchase the books online. By purchasing online, local bookstores are suffering and are looking for a way to adapt to the new market, but, thus far, the local bookstores have been unable to respond to this effectively.

### SUMMARY OF THE INVENTION

To generate customer loyalty, a management system and method is implemented to ensure a purchase or rental is made while at a store. The management system enables a user to set specific goals or requirements, and then the system provides an interface to the user to reach those goals including generating marketing schemes. The management system is also able to be used by a customer to compare prices of items and make a single purchase of items in disparate locations while in the store.

In one aspect, a method of achieving a goal in retail store comprises uploading an existing inventory, inputting purchase prices and margin goals, providing feedback to a user regarding the margin goals and a search of comparative prices and adjusting the margin goals based on the feedback. The method further comprises generating a free online retail store. The method further comprises generating a marketing campaign. The feedback comprises an online report that shows pricing performance of the existing inventory and how competitive the pricing performance is with online suppliers. The method further comprises putting competitive pricing comparison shopping online using simple retail shelf talkers. The method further comprises automatically generating pricing to achieve the margin goals.

In another aspect, a device for enabling a user to set and achieve a goal comprises a memory for storing an application, the application for uploading an existing inventory, inputting purchase prices and margin goals, providing feedback to the user regarding the margin goals and a search of comparative prices and adjusting the margin goals based on the feedback and a processing component coupled to the memory, the processing component configured for processing the application. The application is further for generating a marketing campaign. The feedback comprises an online report that shows pricing performance of the existing inventory and how competitive the pricing performance is with online suppliers. The application is further putting competitive pricing comparison shopping online using simple retail shelf talkers. The application is further automatically generating pricing to achieve the margin goals. The device acts as a universal affiliate cart including receiving a percentage of profits from non-in-store sales. The device further includes a mobile infrastructure to support price comparison in a store using any mobile device supporting text messaging and/or a mobile browser.

In yet another aspect, a mobile device for comparative shopping comprises a memory for storing an application, the application for inputting an item to search for, displaying a list of items along with comparative prices, selecting one or more items for purchase and/or rental and submitting a payment to the store and a processing component coupled to the memory, the processing component configured for processing the application. The store is paid a percentage of a sale/rental regardless of where the items are purchased/rented from. The application automatically generates the list of items based on a class major. The application automatically generates the list of items based on a class list. The comparative prices include prices of bundled items. The bundled items are based on a class list. Items unrelated to the searched for item but relevant to a user are presented to the user for purchase.

### BRIEF DESCRIPTION OF THE DRAWINGS

FIG. 1 illustrates a flowchart of a method of a manager using the management system according to some embodiments.

FIG. 2 illustrates a flowchart of a method of a customer purchasing or renting items while using the management system according to some embodiments.

FIG. 3 illustrates a block diagram of an exemplary computing device configured to implement a management system according to some embodiments.

FIG. 4 illustrates a network of devices configured to utilize the management system according to some embodiments.

### DETAILED DESCRIPTION OF THE PREFERRED EMBODIMENT

By providing many options for customers, stores such as college bookstores are able to generate loyal customers. Options enable a customer to either purchase items, rent items or a combination of the two. Additionally, options allow the customer to decide where he wants to purchase or rent the items from such as in-store or online. Furthermore, the ability to provide competitive pricing also assists a store in gaining loyal customers. Competitive pricing is implemented using price comparisons, pricing analytics, special offers, directed marketing, scannable tags and any other implementation. An example of competitive pricing includes instead of giving one price for one book, one price is given for eight books which allows some books to be discounted more than if they were sold individually.

There are many features/aspects of the system and method described herein. An online storefront which is web-enabled, mobile-enabled, SMS-enabled or any other implementation allows a brick-and-mortar store to present a digital storefront to users. An inventory ledger is able to be used to track a store's inventory which is able to be used for purchasing, sales offers and other analysis. Using a variety of tools, pricing of sales and rentals is able to be competitive and variable depending on a store owner's selections such as margin rules or rental goals. Competitive pricing is also able to incorporate online data such as online prices from trusted retailers (e.g. Amazon.com or Half.com). Using the tools, optimized in-store merchandising including brochures, flyers, QR codes and other items that direct a customer to a purchase are able to be generated easily. In-store price shelftalkers which are printed cards/signs attached to a store shelf to call a customer's attention to the item displayed on that shelf are also able to be generated. In some embodiments, the shelftalkers include linking via QR codes, short book codes or any other implementation. Discount and promotion tools are able to be used to optimize orders and monitor/maintain a business's margin. Analytics of in-store (e.g. in-store conversion rate) and online traffic (e.g. scans versus purchases and purchases versus online price) also assist a store owner in determining a strategy. A universal affiliate cart which monitors where items are purchased from (e.g. online instead of in-store) enables a store to collect a portion of the profits that go to the online store. Used inventory pricing and acquisition (e.g. system purchases a book from a bookstore and then rents out the book to students) is able to be implemented using the system. The system is able to incorporate Point of Sale (POS) for online order pickup or shipping (e.g. student orders book while in-store from an online site). Multi-item pricing (including discounts) is able to be implemented. An in-store help system and training for use on mobile devices will provide users a better understanding of the system and the advantages it gives them. In-class group buying (e.g. write a URL on the board and if 10 students order the book that day, all of those orders will receive a discount) is able to be utilized to benefit the students. Inventory refill where the system recommends a list of refills to a store manager who just approves or declines the recommendations further assists a store. Sell-to-rent lowers the barrier to entry on rentals. Inventory control for rental returns and margin editing enables further analysis by the store.

The price comparison is able to be static price comparison or real-time dynamic pricing. Static price comparison includes comparing the prices available in-store, online and at other stores or wherever additional prices are able to be found. Real-time dynamic pricing is able to be based on store data, online data, and other data, where based on the comparison prices change

In some embodiments, the store is able to profit whether items are purchased or rented from the store or if purchased or rented online or elsewhere. Referred to as a universal affiliate cart, once a user goes to a store and searches for an item, regardless of where he ultimately purchases the item, the store receives a certain amount of money from that sale. For example, a user is able to make a purchase in-store or buy at an online site using a mobile device while in the store, and the store is treated as an affiliate and receives a percentage of the sale.

In some embodiments, renting an item includes receiving a rental order, printing a sticker such as a bar code, placing the sticker on the item and scanning the sticker. In some embodiments, in-store pickup after ordering using SMS or other mobile device technology is implemented.

A user is able to purchase a set of books (e.g. a Pre-Med set) and receive a discount. The system is able to recognize sets of books based on one or more books. For example, a user selects a Chemistry 101 book, the system assumes or asks if user is a Pre-Med student and offers a set of Pre-Med books. In some embodiments, the set of books is able to be edited by the user.

In an example of the management system and price comparison shopping in effect, a student goes to a bookstore needing twelve books; he buys four, rents four and orders four online, all in one transaction.

### Store Manager Perspective

For example, a store manager has a list of book data such as new books and used books. The manager uploads the data to a management system. The upload is able to be in any file format. The management system parses the file and extracts the desired data to populate the inventory list (e.g. inventory ledger). The store manager is able to tweak an interface (e.g. web interface), the overall rules (lowest margin and highest margin), or other information to achieve their ultimate goal. The manager is able to have other goals besides pure profit (e.g. generate foot traffic). The store manager is able to input that he wants to break even on textbooks but is hopeful that he will make money based on clothing sales. The margin is able to be specific to a single book, a group of books, an entire store or any other grouping of books. The management system takes the input information and then provides an interface to the store manager to see if his input is reasonable compared to a global search. The comparison is against other stores using the management system and/or online stores such as Amazon.com and Half.com. The store manager is then able to adjust his goals based on what he sees. The store manager is presented with a multi-SKU interface. The store manager is also able to use the information to generate merchandising and marketing material. The management system facilitates the custom printing by presenting templates and other information. Once the manager sets his prices, he receives feedback from the management system, is able to firm up prices, enable printing (directly or through a third party) of marketing collateral using those prices which includes QR codes or the ability to have a text-based interface with the management system. For example, a shelf-talker will display a Chemistry 101 book to buy for X price, rent for Y price or the user can learn more about renting. The management system also enables competitive pricing by showing what an item costs on Amazon.com and Half.com or other sites to compare. The store manager is able to configure what the comparison points are.

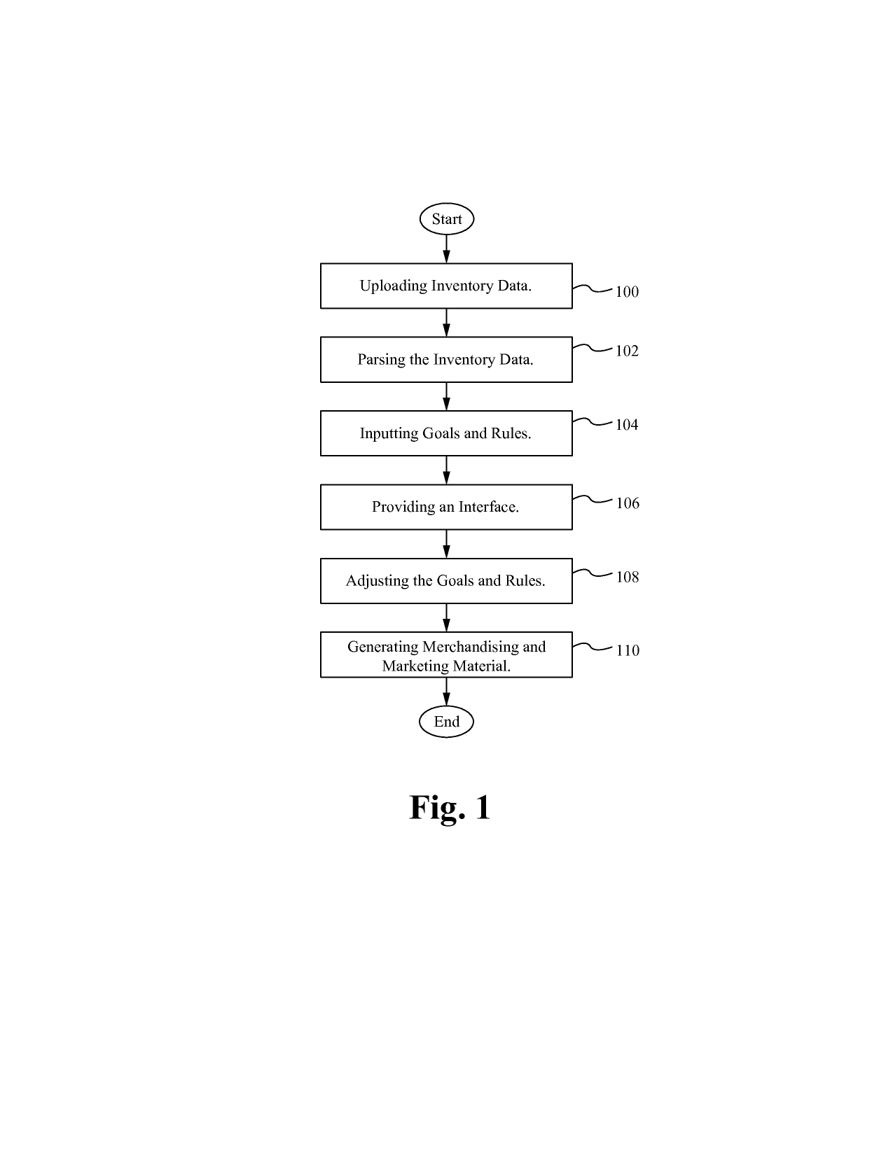

FIG. 1 illustrates a flowchart of a method of a manager using the management system according to some embodiments. In the step 100, a user uploads data such as a book inventory to a management system. In some embodiments, the inventory is automatically uploaded to or automatically generated by the management system. In the step 102, the management system parses the file and extracts the desired data to populate an inventory list (e.g. inventory ledger). In the step 104, the store manager inputs the overall rules (e.g. lowest margin and highest margin), and/or other information to achieve his ultimate goal into an interface (e.g. web interface). In the step 106, the management system takes the input information and then provides an interface to the store manager to see if his input is reasonable compared to a global search. In the step 108, the store manager is then able to adjust his goals based on what he sees. In the step 110, the store manager uses the information to generate merchandising and marketing material. In some embodiments, fewer or more steps are implemented. Furthermore, in some embodiments, the steps are implemented in a different order.

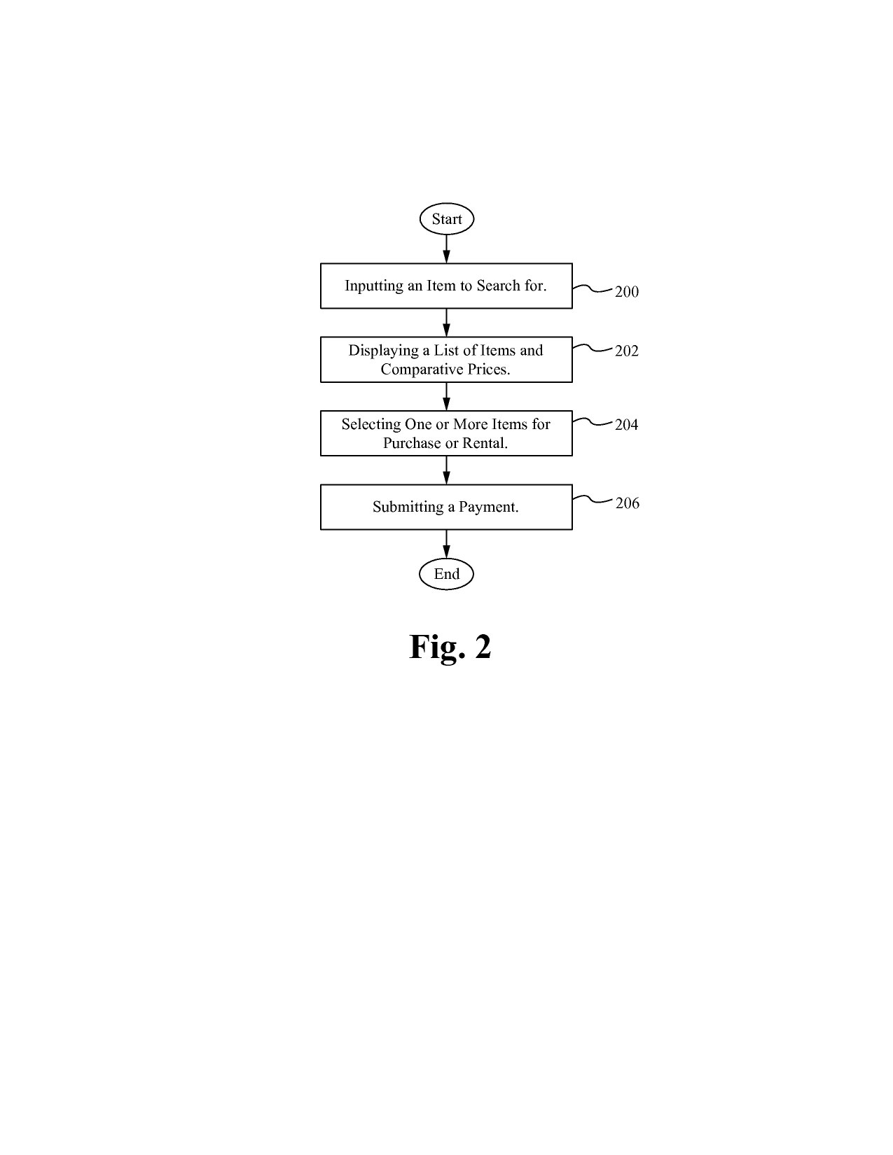

FIG. 2 illustrates a flowchart of a method of a customer purchasing or renting items while using the management system according to some embodiments. In the step 200, a user inputs the items he is looking for. In some embodiments, the user does not input the items, as the list is automatically generated for him or another implementation provides a list for the user. In the step 202, a list of items along with comparative prices is displayed. The comparative prices include in-store prices, online prices and any other available prices, including rental prices and purchase prices. In some embodiments, not only are comparative prices displayed, but deals and other marketing is provided. In the step 204, the user selects one or more items for purchase and/or rental. The purchase/rental is able to include items in-store, online for pickup at the store or home delivery or any other store. In the step 206, in conjunction with the step 204, a payment is submitted to the store. The payment is able to be direct payment if the purchase/rental is in-store items only and/or an affiliate payment if the purchase/rental is from an online store or elsewhere. In some embodiments, fewer or more steps are implemented. Furthermore, in some embodiments, the steps are implemented in a different order.

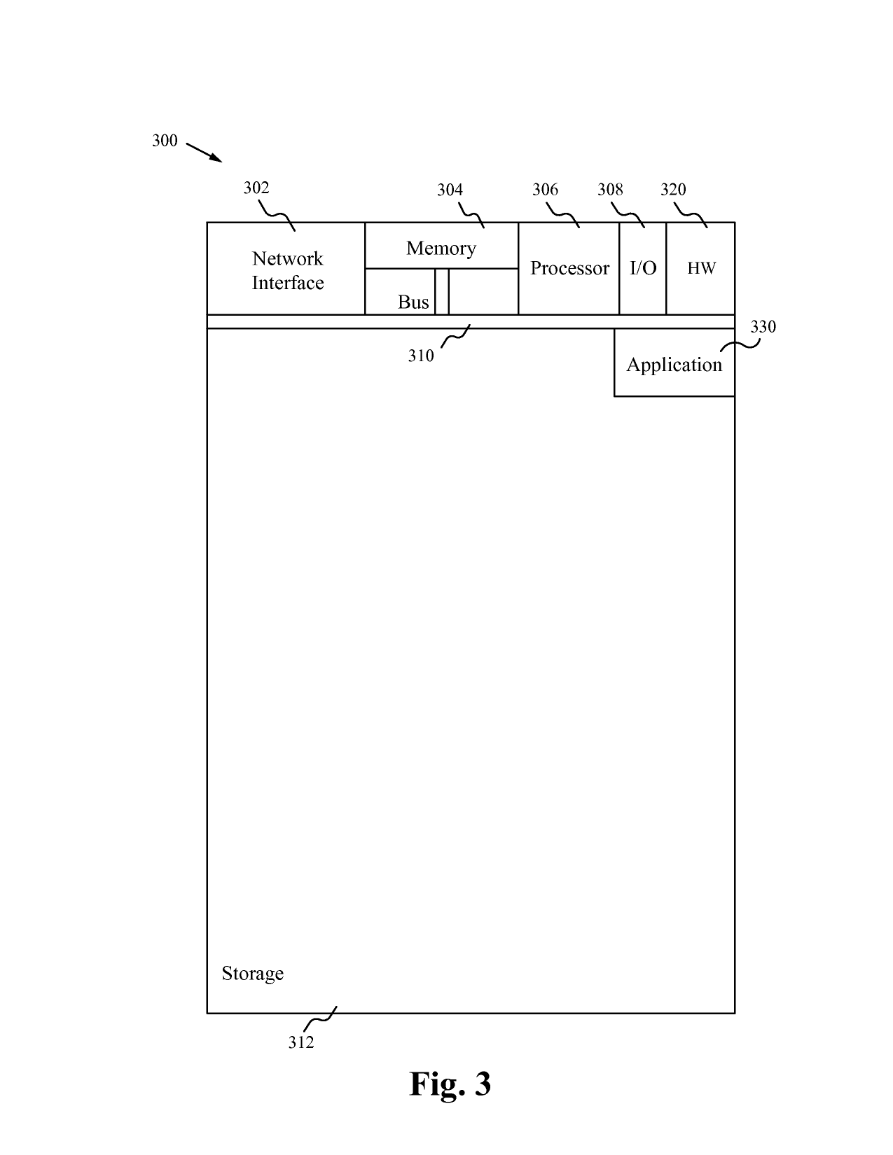

FIG. 3 illustrates a block diagram of an exemplary computing device 300 configured to implement the management system according to some embodiments. The computing device 300 is able to be used to receive, send, compute, process, communicate and/or display information such as comparative book purchase/rental prices, inventory lists, purchase/rental information, sales information, management information and any other relevant information. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. In some embodiments, the hardware structure includes multiple processors and other hardware to perform parallel processing. Management system application(s) 330 used to perform the management operations are likely to be stored in the storage device 312 and memory 304 and processed as applications are typically processed. More or less components shown in FIG. 3 are able to be included in the computing device 300. In some embodiments, Management system hardware 320 is included. Although the computing device 300 in FIG. 3 includes applications 330 and hardware 320 for implementing the management system, the management system is able to be implemented on a computing device in hardware, firmware, software or any combination thereof. For example, in some embodiments, the management system applications 330 are programmed in a memory and executed using a processor. In another example, in some embodiments, the management system hardware 320 is programmed hardware logic including gates specifically designed to implement the method.

In some embodiments, the management system application(s) 330 include several applications and/or modules. Modules include, but are not limited to an online storefront module which allows a brick-and-mortar store to present a digital storefront to users; an inventory ledger module tracking a store's inventory which is able to be used for purchasing, sales offers and other analysis; a competitive pricing module for incorporating online data such as online prices from online retailers; an optimized in-store merchandising module for generating merchandising such as brochures, flyers, QR codes and other items that direct a customer to a purchase are able to be generated easily; an in-store price shelftalker module for generating shelftalkers, a discount and promotion tool module for generating and customizing discounts and promotions that are able to be used to optimize orders and monitor/maintain a business's margin; an analytics module for analyzing in-store and online traffic to assist a store owner in determining a strategy; a universal affiliate cart module for monitoring where items are purchased from (e.g. online instead of in-store) and enabling a store to collect a portion of the profits that go to the online store; a used inventory pricing and acquisition module for acquiring items and renting the items; a multi-item pricing module for providing pricing and discounts for multi-item purchases; an in-store help module for use on mobile devices to provide users a better understanding of the system and the advantages it gives them; an in-class group buying module for enabling classes of students to receive a discount; and an inventory refill module for recommending a list of refills to a store manager who just approves or declines the recommendation. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone/iPad, a video player, a DVD writer/player, a Blu-ray® writer/player, a television, a home entertainment system or any other suitable computing device.

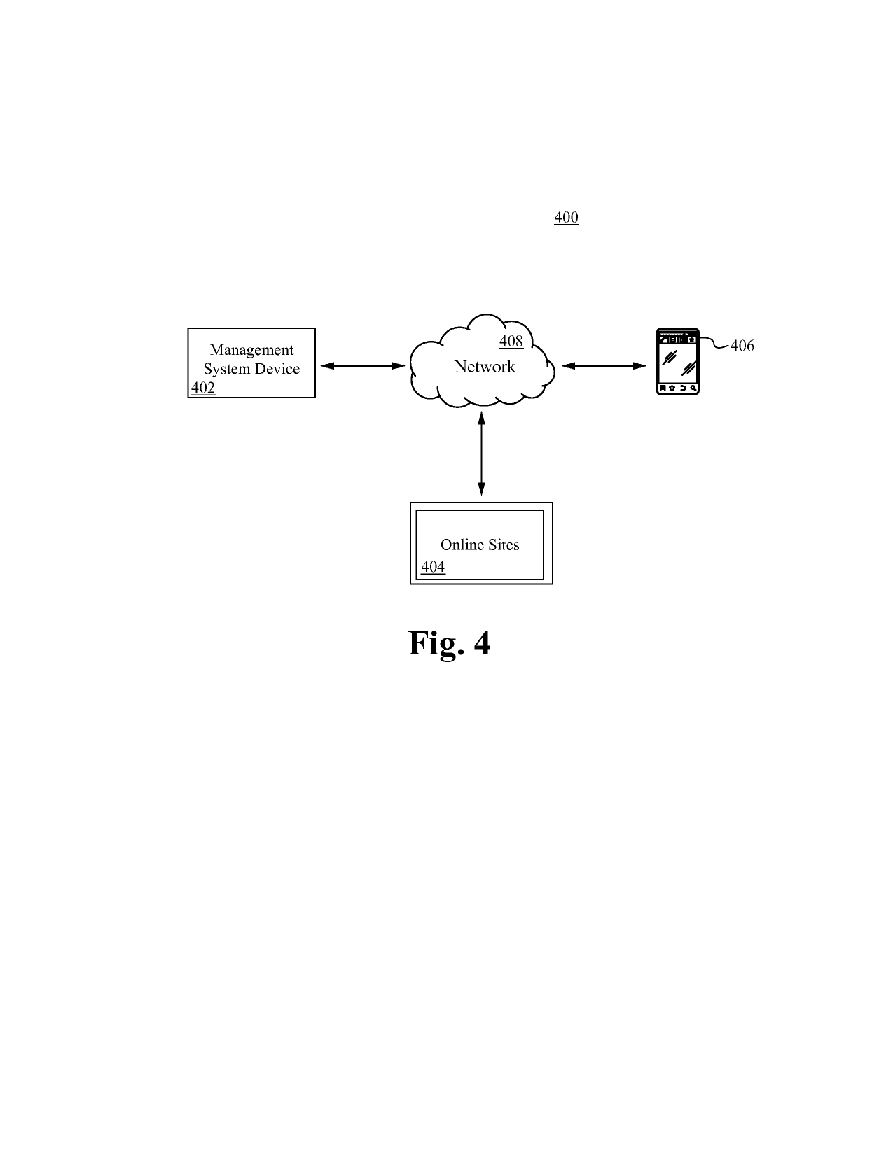

FIG. 4 illustrates a network of devices configured to utilize the management system according to some embodiments. The network of devices 400 is able to include any number of devices and any various devices including, but not limited to a management system device 402, online site devices 404 and a smart device 406 (e.g. a smart phone) coupled through a network 408 (e.g. the Internet). The management system device 402 enables a user to input inventory information and desired goals, perform price comparisons (for example, communicating with online sites 404 to determine prices), process orders, generate marketing products and handle any other management system tasks/requests. The smart device 402 is able to be used by a customer in the store to comparison shop for items such as books on his class book list by searching for prices on online sites 404. The smart device 402 is also able to be used to place orders such as purchases and rentals, as well as perform other tasks described herein. The network 408 is able to any network or networks including, but not limited to the Internet, an intranet, a LAN/WAN/MAN, wireless, wired, Ethernet, satellite, a combination of networks, or any other implementation of communicating. The devices are able to communicate with each other through the network 408 or directly to each other.

Additional examples of use of the smart device 402 include automatically generating a list of items for purchase or rental based on a class major or a class list, presenting comparative prices including bundled item prices (e.g. if a student purchases three Biology texts, the price is $150 total, but individually, each is $55), bundling items automatically based on a class major or class list (e.g. since a student is a Biology major, he can purchase the class list of books for $350 instead of each individually which would cost $400), and presenting items unrelated to a searched for item but relevant to a user for purchase (e.g. since the student is a Biology major at Stanford, suggest a Stanford sweatshirt).

By using the management system, a retailer is able to set up a free online retail store within minimal time (e.g. 5 minutes). An administration page enables a retailer to upload his existing inventory, purchase price and margin goals (prices the products are offered at today).

An online report shows the pricing performance of the existing inventory and how competitive it is with online suppliers such as Amazon.com, eBay.com and others. A product offering for putting competitive pricing comparison shopping online using simple retail shelf talkers is also implemented. Furthermore, a complete mobile infrastructure to support price comparison in the store using any standard mobile device which supports text messaging and mobile browsers is usable.

In operation, the management system allows a user to specify goals and other limitations and then based on those goals and/or limitations, the system will adjust prices, generate marketing products and provide additional assistance to achieve those goals. From a customer's perspective, the customer will be able to purchase products at the best rate possible by utilizing competitive pricing based on the in-store price, online prices and any other prices or deals.

To utilize the management system, the management system provides a user (e.g. manager) a set of tools, the user updates his inventory, sets desired goals/rules, updates marginals/retail bullets such as transactions/cart size, interface with mobile device and shelf talker to generate dynamic pricing to manage against those rules.

Although books have been used as an example herein, the method and system is applicable to any retail items including, but not limited to electronics, clothing and any other items.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of achieving a goal in retail store comprising:
a. uploading an existing inventory;
b. inputting purchase prices and margin goals;
c. providing feedback to a user regarding the margin goals and a search of comparative prices; and
d. adjusting the margin goals based on the feedback.

2. The method of claim 1 further comprising generating a free online retail store.

3. The method of claim 1 further comprising generating a marketing campaign.

4. The method of claim 1 wherein the feedback comprises an online report that shows pricing performance of the existing inventory and how competitive the pricing performance is with online suppliers.

5. The method of claim 1 further comprising putting competitive pricing comparison shopping online using simple retail shelf talkers.

6. The method of claim 1 further comprising automatically generating pricing to achieve the margin goals.

7. A device for enabling a user to set and achieve a goal, comprising:
a. a memory for storing an application, the application for:
i. uploading an existing inventory;
ii. inputting purchase prices and margin goals;
iii. providing feedback to the user regarding the margin goals and a search of comparative prices; and
iv. adjusting the margin goals based on the feedback; and
b. a processing component coupled to the memory, the processing component configured for processing the application.

8. The device of claim 7 wherein the application is further for generating a marketing campaign.

9. The device of claim 7 wherein the feedback comprises an online report that shows pricing performance of the existing inventory and how competitive the pricing performance is with online suppliers.

10. The device of claim 7 wherein the application is further putting competitive pricing comparison shopping online using simple retail shelf talkers.

11. The device of claim 7 wherein the application is further automatically generating pricing to achieve the margin goals.

12. The device of claim 7 wherein the device acts as a universal affiliate cart including receiving a percentage of profits from non-in-store sales.

13. The device of claim 7 wherein the device further includes a mobile infrastructure to support price comparison in a store using any mobile device supporting text messaging and/or a mobile browser.

14. A mobile device for comparative shopping comprising:
a. a memory for storing an application, the application for:
i. inputting an item to search for;
ii. displaying a list of items along with comparative prices;
iii. selecting one or more items for purchase and/or rental; and
iv. submitting a payment to the store; and
b. a processing component coupled to the memory, the processing component configured for processing the application.

15. The mobile device of claim 14 wherein the store is paid a percentage of a sale/rental regardless of where the items are purchased/rented from.

16. The mobile device of claim 14 wherein the application automatically generates the list of items based on a class major.

17. The mobile device of claim 14 wherein the application automatically generates the list of items based on a class list.

18. The mobile device of claim 14 wherein the comparative prices include prices of bundled items.

19. The mobile device of claim 18 wherein the bundled items are based on a class list.

20. The mobile device of claim 14 wherein items unrelated to the searched for item but relevant to a user are presented to the user for purchase.
